(19) United States
(12) Patent Application Publication
(10) Pub. No.: US 2026/0210761 A1
(43) Pub. Date: Jul. 23, 2026

(54) OPTICAL EMISSION SPECTROMETER AND METHOD OF ANALYSING A SPECTRAL PEAK

(71) Applicant: Thermo Fisher Scientific (Bremen) GmbH, Bremen (DE)

(72) Inventor: Ningning Pan, Bremen (DE)

(73) Assignee: Thermo Fisher Scientific (Bremen) GmbH, Bremen (DE)

(21) Appl. No.: 19/140,610

(22) PCT Filed: Dec. 20, 2023
(86) PCT No.: PCT/EP2023/086979

§ 371 Date: Jun. 18, 2025

(30) Foreign Application Priority Data
Dec. 20, 2022 (GB) 2219259.5

(51) Int. Cl. G01J 3/02; G01J 3/18; G01J 3/28; G01J 3/443; G01N 21/27

(52) U.S. Cl. CPC G01J 3/0297; G01J 3/1809; G01J 3/2803; G01J 3/2823; G01J 3/443; G01N 21/274; G01J 2003/2859

(57) ABSTRACT

A method of analysing a spectral peak obtained by an optical spectrometer is provided. The method comprises imaging a spectral peak using an optics assembly and a detector of the optical spectrometer to generate a detected image of the spectral peak. An image correction function is applied to the detected image of the spectral peak to obtain a corrected image of the spectral peak, wherein the image correction function increases the spectral power density of the spectral peak in the corrected image of the spectral peak. Information representative of the spectral peak is extracted from the corrected image of the spectral peak.

### FIELD OF THE DISCLOSURE

The present disclosure relates to optical spectrometry. In particular, the present disclosure relates to the analysis of spectral peaks obtained by an optical spectrometer.

### BACKGROUND

Optical spectrometry, for example optical emission spectrometry is an analytical technique for analysing a sample. In optical emission spectrometry, a sample may be excited, for example using a plasma source. The excited atoms of the sample emit light, wherein the wavelength of the light emitted is characteristic of the atoms present in the sample. As such, the light emitted by the sample comprises a plurality of spectral peaks, wherein each spectral peak corresponds to a specific energy level transition in an atom. By detecting the presence of spectral peaks at specific wavelengths, the presence of an element in the sample can be determined. Furthermore, the intensity of each spectral speak can be used to analyse the concentration of elements within the sample.

Various optical spectrometry techniques involve the imaging of spectral peaks on a detector. Often, some form of optical assembly is used to guide the light to be analysed to the detector. For example, optical emission spectrometers (OES) typically include an echelle grating in order to diffract light into a two-dimensional spectrum, wherein the two-dimensional spectrum is imaged by an array detector. In such a system, a spectral peak corresponding to a narrow wavelength may appear as a bright “spot” on the detector. The wavelength of the spectral peak may be inferred from its location on the detector

As such, an optical spectrometer such as an optical emission spectrometer may generate a plurality of spectral peaks when analysing a sample. Part of the process of analysing the plurality of spectral peaks involves the identification of spectral peaks from the measurement data. The identification process typically involves fitting a curve to the measurement data in order to identify a peak location (and associated wavelength), and a peak intensity. The peak wavelength and intensity can be used to determine the element(s) present in the sample and the relative quantity of each element.

Accordingly, the present disclosure seeks to provide a method for analysing a spectral peak that tackles at least one of the problems associated with prior art methods, or at least, provide a commercially useful alternative thereto.

### SUMMARY

According to a first aspect of the disclosure, a method of analysing a spectral peak obtained by an optical spectrometer is provided. The method comprises:
imaging a spectral peak using an optics assembly and a detector of the optical spectrometer to generate a detected image of the spectral peak;
applying an image correction function to the detected image of the spectral peak to obtain a corrected image of the spectral peak, wherein the image correction function increases the spectral power density of the spectral peak in the corrected image of the spectral peak; and
extracting information representative of the spectral peak from the corrected image of the spectral peak.

The present inventors have realised that the optics assembly of a spectrometer introduces optical distortion into the image of a spectral peak which is recorded by the detector of the spectrometer. For example, the optical distortion may, in effect, blur, or add other noise to the image which is incident on the detector. The effect of such optical distortion is to distribute the energy associated with a spectral emission across a wavelength range. In effect, the spectral power density of the detected spectral peak is reduced. The present invention provides an image correction function to correct for the optical distortion introduced by the optics assembly of the spectrometer. In particular, the image correction function is configured to correct a detected image by increasing the spectral power density of the spectral peak.

It will be appreciated that the present inventors are applying an image correction function to correct a two-dimensional image of a spectral peak. As such, the method of the first aspect aim to capture energy associated with the spectral peak which has been distorted in two dimensions. That is to say, the image correction function is configured to correct for the “blurring” of the spectral peak by transferring energy from the edges of the spectral peak towards the centre of the peak. Once the corrected image is obtained, information representative of the spectral peak may be extracted from the corrected image. It will be appreciated that the extracted information may then subsequently be subjected to further information processing steps such as curve-fitting, identification of elements present in the sample, and the like.

In some embodiments, applying an image correction function to the detected image of the spectral peak comprises:
obtaining a predicted image correction function for the spectral peak based on optical characteristics of the optics assembly and the detector of the spectrometer; and
generating a predicted image of the spectral peak based on the predicted image correction function; and
generating the calibrated image correction function based on the predicted image correction function and a comparison of the predicted image of the spectral peak and the detected image of the spectral peak,
wherein the calibrated image correction function is applied to the detected image of the spectral peak to obtain a corrected image of the spectral peak.

As such, the present inventors have realised that various image correction functions which can be applied to increase the spectral power density of a spectral peak. The present inventors have realised that while it is possible to make an initial prediction of an image correction function which is representative of the distortion introduced by the optics assembly, the initial predicted image correction function often does not completely capture the random noise present in the detected image. Thus, in order to improve the corrected image of the spectral peak obtained (e.g. further increase the spectral power density), in some embodiments the method may further calibrate the image correction function. The calibration may be performed by using the predicted image correction function to generate a predicted image of the spectral peak that would be obtained by the optical spectrometer and comparing said predicted image to the detected image. Based on any differences between the predicted image and the detected image, the method may then generate a calibrated image correction function (e.g. by iterating the predicted image correction function) having improved performance (e.g. improved spectral power density).

In some embodiments, obtaining a corrected image of the spectral peak using the calibrated image correction function comprises deconvolving the detected image of the spectral peak with the calibrated image correction function to obtain a corrected image of the spectral peak. As such, in some embodiments, the predicted image correction function is a predicted point spread function (PSF), and the calibrated image correction function is a calibrated point spread function (PSF). Thus, convolution may be used to generate the predicted image from the predicted PSF. Subsequently, deconvolution may be used to obtain a corrected image of the spectral peak from the calibrated image correction function (calibrated PSF) and the detected image.

In some embodiments, the calibrated image correction function is calculated by convolving the predicted image correction function with a noise function, wherein the noise function is calculated based on the comparison of the predicted image of the spectral peak and the detected image of the spectral peak. As such, by taking into account random noise which affects the optical assembly, the calibrated image correction function may more accurately account for the distortion present in the detected image. Accordingly, the resulting corrected image may more accurately reflect the spectral peak (spectral image) being measured.

In some embodiments, the noise function comprises a matrix-of-all-ones (sometimes referred to as a unit matrix). In some embodiments, the noise function may be a matrix-of-all-ones of variable size. By varying the size (order) of the noise function, the impact of the noise function when calculating the calibrated image correction function may be adjusted to more accurately reflect the noise present in the optical spectrometer.

In some embodiments, a blind deconvolution process may be used to generate a calibrated image correction function/corrected image.

In some embodiments, the image correction function may be formulated using an image regularisation process. That is to say, the image degradation process may be expressed in the form of:

$$y = Hx + n$$

where y is the detected image, x is the original (undistorted image), H is a linear degradation operator and n is a noise vector. The objective function of x is defined based on different constraint sets. The solution is then obtained by minimizing the objective function (image correction function) with respect to x. As such, an image correction function can be obtained by an image regularisation process to determine the corrected image y.

In some embodiments, the calibrated image correction function is calculated iteratively. In some embodiments, the iteration is performed until a difference between the predicted image of the spectral peak and the detected image of the spectral peak is below a predetermined threshold. For example, the difference between the predicted image and the detected image may be quantified, and subsequent iterations of the calibrated image function may seek to reduce the quantified difference between the predicted image and the detected image. In some embodiments, the iteration may be performed until the quantified difference is below a predetermined threshold. Thus, each calibrated image correction function may achieve a certain level of improvement based on the threshold. Additionally or alternatively, in some embodiments, the iteration may be performed no more than a predetermined number of times in order to prevent the iteration from running for an extended period of time for example.

In some embodiments, the difference between the predicted image of the spectral peak and the detected image of the spectral peak is calculated using an image hash algorithm. For example a perceptive image hash algorithm, or a wavelet image hash algorithm may be used.

In some embodiments where a noise function is used, in each iteration of the calibrated image correction function calculation, the order of the noise function is increased.

In some embodiments, imaging the spectral peak comprises selecting a sub-region of the detector to form the detector image of the spectral peak, wherein the predicted image correction function and the predicted image are generated for the selected sub-region of the detector. For example, in some embodiments the detector of the optical spectrometer may be an array detector comprising a two-dimensional arrangement of pixels. Such an array detector may instantaneously record a plurality of spectral peaks at a plurality of different locations on the detector. As such, it will be appreciated that in some embodiments, the image correction function may be applied only to a localised area of the detector. A localised area of the detector may be an area of the detector having a size proportional to that of the spectral peak of interest. For example, a localised area of the detector may have an area which is no greater than: 300%, 250%, 200%, 175%, 150%, or 125% of the area of a spectral peak of interest. That is to say, in some embodiments selecting a sub-region of the detector may comprise selecting a sub-region of the detector in which only a single spectral peak is present such that the detected image comprises a single spectral peak.

In some embodiments where the optical spectrometer comprises an array detector comprising a two-dimensional array of pixels, each sub-region of the detector may have an area of no greater than 2,500 pixels (e.g. 50×50 pixels). In some embodiments, each sub-region of the detector may have an area of no greater than 2000 pixels, 1600 pixels, 900 pixels, 600 pixels, or 400 pixels. It will be appreciated that the sub-regions may be square, rectangular, or any other shape. Preferably the sub-regions are square.

In some embodiments, the sub-region of the detector may be selected based on a wavelength of interest, for example a wavelength of interest specified by a user. Such a wavelength of interest may correspond to a spectral emission/spectral peak associated with an analyte of interest. A sub-region of the detector may then be selected centred around a pixel of the detector associated with the specified wavelength. For example, the sub-region may have a size of at least: 10×10 pixels, 20×20 pixels, or 40×40 pixels, wherein the centre of the sub-region is located at the pixel of the detector associated with the specified wavelength.

In some embodiments, the optics assembly comprises a diffraction grating configured to diffract spectral peaks of different wavelengths to different sub-regions of the detector. In other embodiments, it will be appreciated that other optical components may be provided as part of the optics assembly in order to generate the spectral peak(s) incident on the detector.

In some embodiments, the optics assembly comprises a slit and a diffractive element. The diffractive element may be configured to distribute the spectral peak to be analysed across the detector. In some embodiments, the diffractive element may comprise a diffraction grating, a diffractive prism, or any other suitable optical component. In some embodiments, the diffractive element may be provided by a plurality of (diffractive) optical components. The slit may define a relatively narrow opening through which light is transmitted. The slit may have a known, fixed, width, or in some embodiments, a width of the slit may be adjustable by the optics assembly. In some embodiments, the slit may be a pinhole slit having a fixed, known diameter. In some embodiments, the optical characteristics of the optics assembly may comprise a width of the slit, or a diameter of a pinhole slit. As such, in some embodiments, a width of the slit may be used to determine the predicted image correction function.

In some embodiments, the optics assembly is operable in a first configuration having a first set of optical characteristics, or in a second configuration having a second set of optical characteristics. The differing optical characteristics may be used to, for example, change the resolution of the optical spectrometer, or to increase an exposure time of the detector. The differing optical characteristics may also be used to improve the calibration of the optical spectrometer. For example, a spectral peak may be imaged using the optics assembly in the first configuration (i.e. in a standard mode) to generate the detected image of the spectral peak, and the (same) spectral peak may be imaged using the optics assembly in the second configuration (i.e. an enhancement mode) to generate a calibration detected image of the spectral peak. The calibrated image correction function may be generated based on the predicted image correction function and a comparison of the predicted image of the spectral peak and the calibrated detected image of the spectral peak. The calibrated image correction function may then be applied to the detected image of the spectral peak (i.e. the image obtained in the standard mode) to obtain a corrected image of the spectral peak. As such, an increased resolution calibration detected image may be obtained to calibrate the spectral peak, wherein the calibrated image correction function may then be applied to spectral peaks imaged under a “standard” mode.

In some embodiments, the optical spectrometer is an optical emission spectrometer. As such, imaging the spectral peak comprises exciting a sample to be analysed, wherein spectral emissions from the sample are directed to the detector by the optics assembly. In some embodiments, the sample to be analysed may be excited using a plasma source.

In some embodiments, the optical spectrometer may be an optical absorption spectrometer. For example, the optical absorption spectrometer may comprise a light source, such as a Hollow Cathode Lamp (HCL) or a Deuterium Lamp. In some embodiments, light from the light source may be transmitted through a sample to a detector, wherein some wavelength of light may be absorbed by the sample. Thus, in the case of optical absorption spectrometry the spectral peaks to be analysed correspond to absorption peaks which can be extracted from the detected image. That is to say, in the detected image, the spectral peaks may appear as the absence of light (e.g. minima, or troughs in a graph of wavelength against intensity). However, it will be appreciated that when correcting the detected image and extracting absorption information from the corrected image, the methods according to this disclosure may still be applied.

According to a second aspect of the disclosure, a controller for an optical spectrometer configured to analyse a spectral peak is provided. The controller is configured to:
cause the spectrometer to image a spectral peak using an optics assembly and a detector of the spectrometer to generate a detected image of the spectral peak;
apply an image correction function to the detected image of the spectral peak to obtain a corrected image of the spectral peak, wherein the image correction function increases the spectral power density of the spectral peak in the corrected image of the spectral peak; and
to extract information representative of the spectral peak from the corrected image of the spectral peak.

As such, it will be appreciated that the controller of the second aspect may be utilised to cause an optical spectrometer to perform the method of the first aspect. As such, it will be appreciated that the controller of the second aspect may incorporate any of the optional features, and associated advantages, of the first aspect discussed above.

According to a third aspect, an optical spectrometer is provided comprising: a light source configured to output light, a detector, an optics assembly configured to direct light from the light source to the detector, and a controller according to the second aspect. In some embodiments, the optical spectrometer may be an optical emission spectrometer, wherein the light source comprises a sample which is excited to emit light (spectral emissions), wherein the emitted spectral emissions are detected by the detector.

According to a fourth aspect of the disclosure, a computer program comprising instructions to cause the optical spectrometer of the third aspect to execute the steps of the method of the first aspect is provided. As such, it will be appreciated that the computer program of the fourth aspect may incorporate any of the optional features, and associated advantages, of the first, second, or third aspects discussed above.

According to a fifth aspect of the disclosure, a computer-readable medium having stored thereon the computer program of the fourth aspect is provided. As such, it will be appreciated that the computer-readable medium of the fifth aspect may incorporate any of the optional features, and associated advantages, of the first, second, third, or fourth aspects discussed above.

### BRIEF DESCRIPTION OF THE FIGURES

The invention may be put into practice in a number of ways and specific embodiments will now be described by way of example only and with reference to the figures in which:

FIG. 1 shows a schematic diagram of an optical spectrometry system according to an embodiment of the disclosure;

FIG. 2 shows a schematic diagram of an optics assembly of an optical spectrometry system according to an embodiment of the disclosure;

FIG. 3 shows a schematic diagram of a two-dimensional detector according to an embodiment of the disclosure;

FIG. 4 shows a block diagram of a method of analysing a spectral peak according to an embodiment of the disclosure;

FIG. 5a depicts a detected image of a spectral peak according to this disclosure;

FIG. 5b depicts a corrected image of a spectral peak according to this disclosure;

FIG. 5c shows a graph of the intensity of the spectral peak extracted along an order of the detector for the detected image and the corrected image of FIGS. 5a and 5b respectively;

FIG. 6 shows a block diagram of a step of obtaining a corrected image correction function according to an embodiment of the disclosure;

FIG. 7 shows a block diagram of a step of obtaining a corrected image correction function according to another embodiment of the disclosure;

FIG. 8 shows a graphic representation of one possible method for calculating a predicted image according to this disclosure;

FIG. 9a depicts a detected image of another spectral peak according to this disclosure;

FIG. 9b depicts an image of a calibrated PSF for the detected image of FIG. 9a;

FIG. 9c depicts a corrected image of the spectral peak of FIG. 9a;

FIG. 9d shows a graph of the intensity of the spectral peak extracted along an order of the detector for the detected image and the corrected image of FIGS. 9a and 9c respectively;

FIG. 10a shows a diagram of a slit of an optical spectrometry system in a first position; and

FIG. 10b shows a further diagram of the entrance slit in a second position;

FIG. 11 shows a diagram of part of an optical spectrometry system including of a detector and part of an optics assembly including a slit.

### DETAILED DESCRIPTION

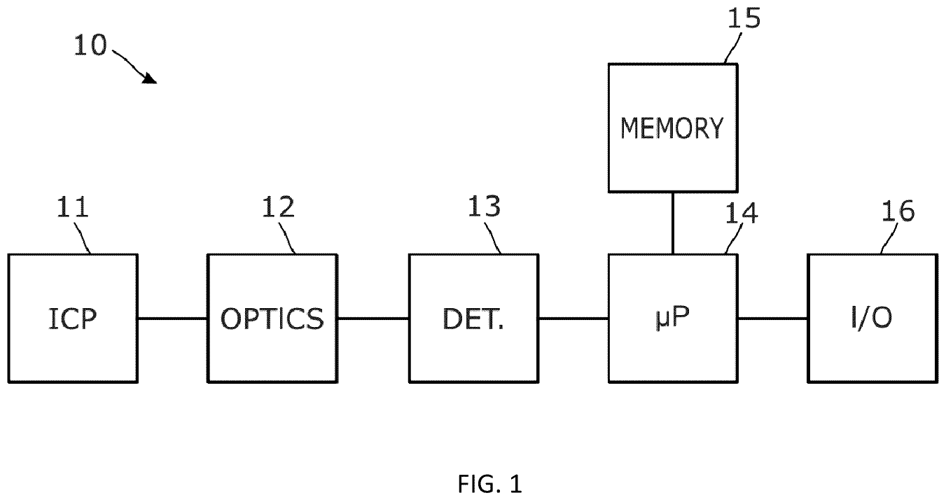

According to an embodiment of the disclosure, an optical spectrometry system 10 is provided. The optical spectrometry system 10 is configured to perform a method of optical spectrometry on a sample in order to generate a sample spectrum. The optical spectrometry system 10 may also analyse a spectral peak of the sample spectrum according to a method of this disclosure. A schematic diagram of the optical spectrometry system 10 is shown in FIG. 1. As shown in FIG. 1, the optical spectrometry system 10 comprises a light source 11, an optical arrangement 12, a detector 13, a processor (μP) 14, a memory 15, and an input/output (I/O) unit 16.

In the embodiment of FIG. 1, the light source 11 is a plasma source, such as an inductively coupled plasma (ICP) source. As such, the optical spectrometry system 10 of FIG. 1 may be an optical emission spectrometry system 10. In other embodiments, the light source 11 may be a furnace or any other high temperature light source which generates excited species suitable for use in optical emission spectrometry. Alternatively, other optical spectrometry systems 10 may provide a light source 11 suitable for the optical spectrometry method being performed. The light source 11 may be configured to receive a sample to be analysed using the optical spectrometry system 10. For example, where the light source 11 is a plasma source, a sample may be introduced into the plasma wherein the sample interacts with the plasma. Samples in aqueous form may be introduced directly into the plasma source, while solid samples may be introduced using laser ablation or vaporisation, for example.

In the embodiment of FIG. 1, the optics assembly 12 may comprise a slit, an echelle grating and a prism (and/or a further grating) to produce a two-dimensional image of the light produced by the light source 11 (and sample if present). An example of an optics assembly 12 is discussed in more detail below. The two-dimensional image is formed on the detector 13. In such an arrangement, it will be appreciated that the optics assembly 12 is configured to direct radiation from the light source 11 to the detector such that the radiation is suitable for detection by the detector 13.

In the embodiment of FIG. 1, the detector 13 may be a CCD (charged coupled device) array. A typical CCD array may have at least approximately 1024×1024 pixels (i.e. 1 Megapixel). The CCD array may be arranged for producing spectrum intensity values corresponding with the measured amount of light of the echelle spectrum, and for transferring the spectrum values to the processor 14. As such, the detector 13 may be a multichannel detector that is configured to detect a plurality of different wavelengths. The detector 13 (such as in the embodiment of FIG. 1) may be configured to detect a two-dimensional spectrum. In other embodiments, the detector 13 may be a CMOS or CID detector.

The processor 14 (controller) may comprise a commercially available microprocessor and the like. The memory 15 can be a suitable semiconductor memory and may be used to store instructions allowing the processor 14 to carry out an embodiment of the method according to this disclosure. The processor 14 and memory 15 may be configured to control the optical spectrometry system 10 to perform methods according to embodiments of this disclosure. As such, the memory 15 may comprise instructions which, when executed by the processor 14, cause the optical spectrometry system 10 to carry out methods according to embodiments of this disclosure.

The optical spectrometry system 10 may be configured to generate a sample spectrum by introducing the sample to the light source 11. The light generated by the light source 11 interacts with the sample wherein spectral emissions that are characteristic of the sample are emitted by the sample. The spectral emissions from the light source 11 and the sample are directed by the optics assembly 12 to the detector 13. The echelle grating (or other diffractive element) of the optics assembly 12 diffracts the spectral emissions of different wavelengths by varying amounts such that the spectral peak associated with each spectral emission are detected at different locations on the detector 13. As such, it will be appreciated that the optical distortion introduced by the optics assembly to the original image (e.g. an image of the slit is distorted by the downstream optical components) will vary with the wavelength of the spectral peak.

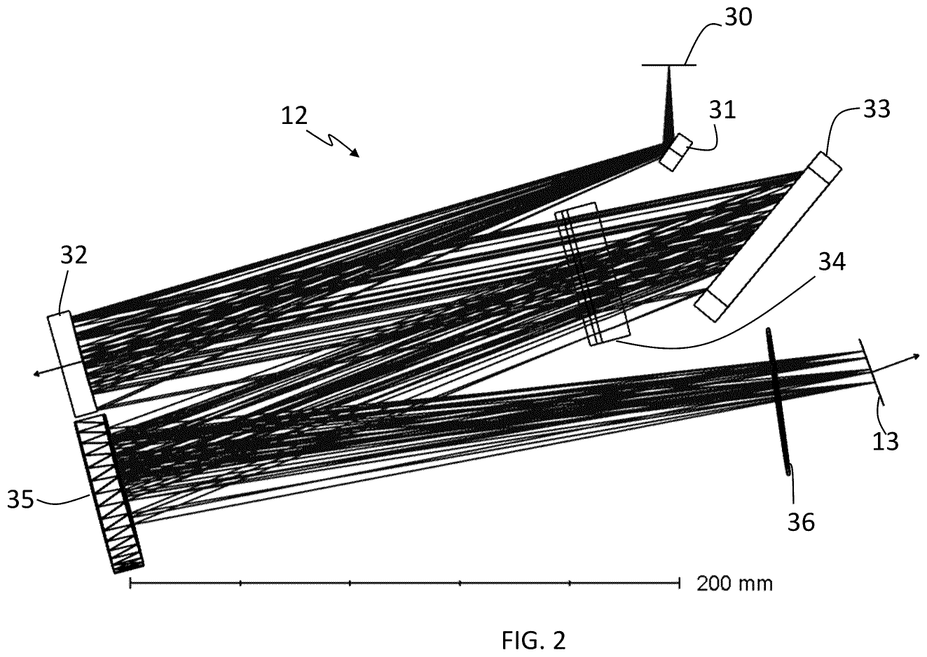

FIG. 2 shows one example of an optics assembly 12 according to this disclosure. The optics assembly of FIG. 2 comprises a slit 30, a first mirror 31, a second mirror 32, an echelle grating 33, a prism 34, a third mirror 35 and a lens 36. As shown in FIG. 2, the light to be analysed enters the optics assembly 12 via a slit 30. As such, the detector 13 effectively images the slit 30, wherein the image of the slit incident on the detector 13 is distorted by the optics assembly 12. As such, the image correction function according to this disclosure attempts to recreate the image of the slit by reversing the distortion introduced by the optics assembly 12.

It will be appreciated that the various mirrors 31, 32, 35, prism 34 and lens 36 are well known to the skilled person, and so are not discussed further herein. The echelle grating 33 is configured to diffract light, in order to distribute the spectrum of light to be analysed across the detector 13. It will be appreciated that optics assembly 12 shown in FIG. 2 is only one example of an optics assembly 12 that may be used in conjunction with this disclosure. That is to say, the methods disclosed herein may be applied to any suitable optics assembly 12 of an optical spectrometer.

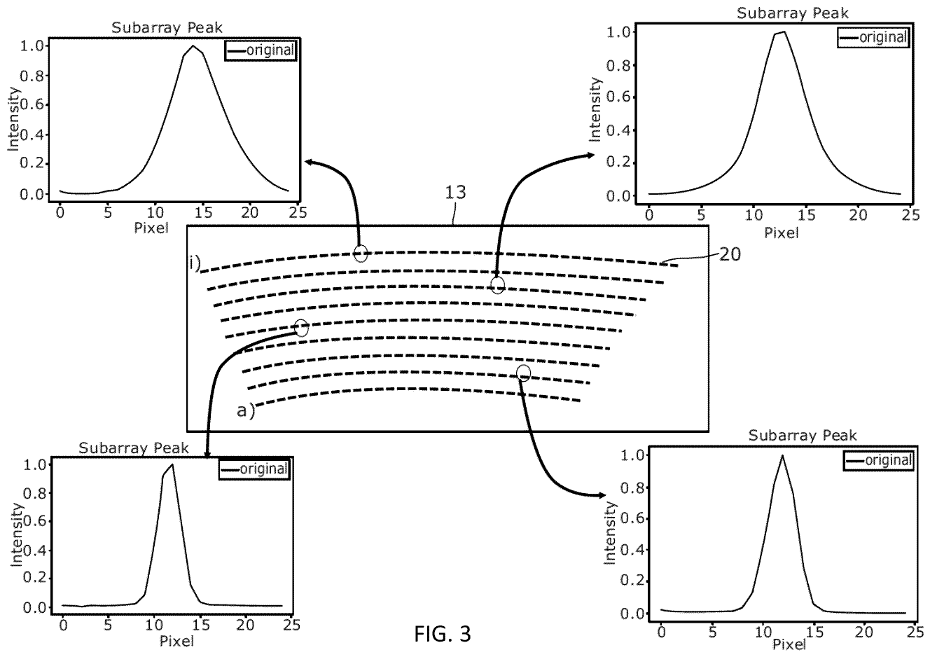

FIG. 3 shows a schematic diagram of a two-dimensional detector 13 of the embodiment of FIG. 1. The two-dimensional detector 13 of FIG. 3 is formed from an array of pixels, although each pixel is not individually represented in FIG. 3. FIG. 3 includes schematic representations (dashed lines) of the orders of light 20 diffracted by the echelle grating and prism which are imaged on the detector 13. Each order 20 corresponds to a different wavelength range, and the wavelength varies in the transverse direction along each order. For example, in the embodiment of FIG. 3, the wavelength of light diffracted may increase along each order from left to right. The starting wavelength may also increase from order a) up to order i). FIG. 3 also shows four detailed views of example single spectral emissions that are imaged by groups of pixels of the detector at different locations on the detector. It will be appreciated that the peak shape of each of the spectral emissions differs based on the optical aberration of the optical arrangement 12. In some embodiments, the optical arrangement 12 may cause a certain wavelength of light to be diffracted to a single location, or a plurality of locations on the detector 13. As such, in some embodiments, a spectral emission may appear in multiple locations on the detector 13.

The detector 13 is configured to output the recorded intensity of each pixel of the detector 13 to the processor 14 for further analysis.

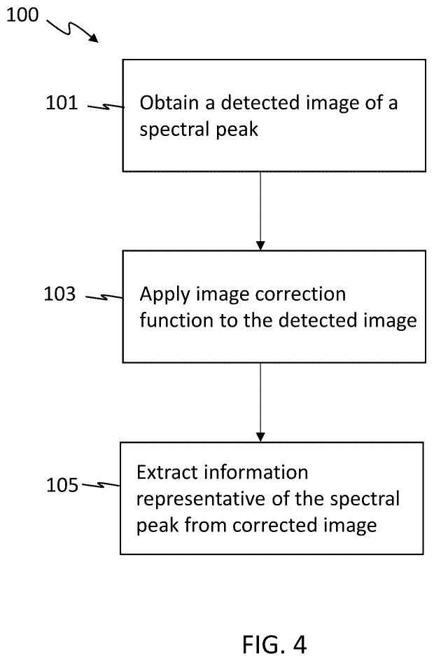

Next, a method 100 of analysing a spectral peak obtained by an optical spectrometer will be described with reference to FIG. 4. The method will be described with reference to the optical spectrometry system 10 of FIG. 1, but it will be appreciated that the method 100 is not limited to the optical spectrometry system 10 described above. Alternatively, the method 100 may be performed by any other processor that is provided with the image of the spectral peak generated by the optical spectrometry system 10.

In step 101 shown in FIG. 4 a detected image of a spectral peak is obtained. It will be appreciated that the detector 13 of the optical spectrometry system 10 is configured to image a plurality of spectral peaks simultaneously. As such, in the embodiment of FIGS. 1 and 4, the full frame image acquired by the detector is cropped in order to focus on a smaller area in which a spectral peak is present. As such, imaging the spectral peak may comprise selecting a sub-region of the detector (corresponding to a sub-region of the detected image) to form the detected image of the spectral peak. For example, the sub-region of the detector may comprise an area of no greater than 2500 pixels. In the embodiment of FIG. 3, the sub-region of the detector 13 from which the detected image is generated has an area of 40×40 pixels. In effect, a 40×40 pixel sub-region may be selected from the full frame image to be used as the detected image for the method 100.

Preferably, a spectral peak of interest is located towards the centre of the detected image. In some embodiments, a centre of gravity of the spectral peak of interest may be used to position the spectral peak towards a centre of the detected image. Alternatively, the sub-region of the detector used to form the detected image may be manually selected by a user of the spectrometry system 10. For example, in some embodiments, a user may specify a wavelength of interest (e.g. a wavelength corresponding to a spectral emission of interest) and the processor 14 may select a pixel along an order of the detector 13 associated with the wavelength, wherein the sub-region of the detector 13 is selected based on the selected pixel. For example, the selected pixel may be located at a centre of the sub-region.

In some embodiments, the detected image of the spectral peak may be subject to one or more pre-processing steps. For example, a background correction step may be performed on the detected image of the spectral peak prior to applying the image correction function. A background correction step may comprise removing background noise present in the detected image based on a measurement of the background noise in the image. Background correction of the detected image may be performed to remove spectral emissions associated with the plasma (e.g. spectral emission of Ar where an Ar plasma is used) to reduce or remove shot noise from the detected image.

In step 103, an image correction function is applied to the detected image in order to generate a corrected image of the spectral peak. The image correction function is configured to increase the spectral power density of the spectral peak in the corrected image of the spectral peak. As such, the correction process transfers power from the fringes of the peak in the detected image and towards the centre, such that the corrected image of the spectral peak is more representative of the spectral power of the spectral emission being imaged.

Further details of applying the image correction function in step 103 are provided below.

In step 105, information is extracted from the corrected image of the spectral peak which is representative of the spectral peak. For example, in some embodiments the processor 14 (as shown in FIG. 1) may extract intensity information of the pixels along one order 20 (as shown in FIG. 3) of the detector 13 in order to form a graph of intensity against pixel number. Based on a known relationship between the pixel locations and wavelength, the processor may then infer wavelength and intensity information about the spectral peak.

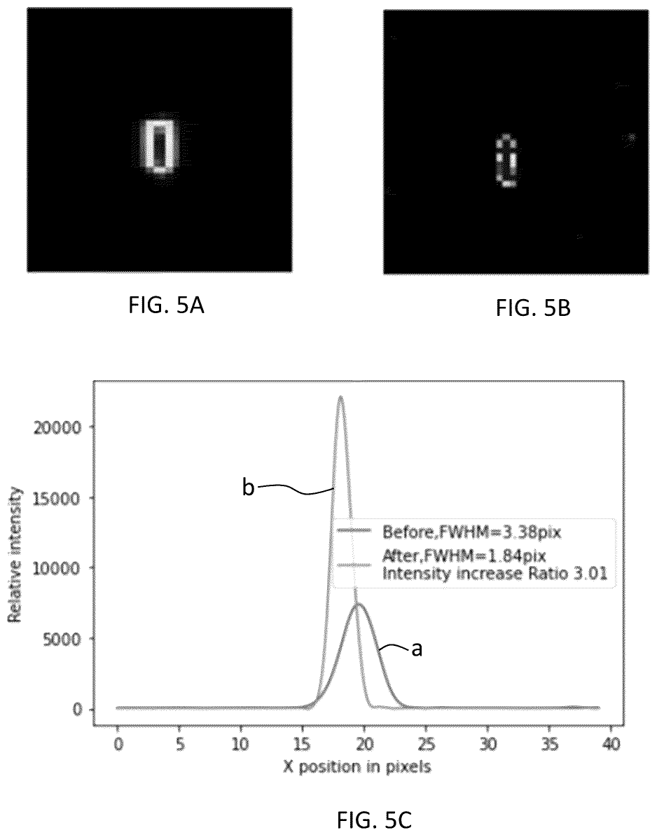

For example, FIGS. 5a, 5b, and 5c show examples of a detected image, a corrected image, and a graph of a spectral peak extracted from each of the two images for comparison. As shown in FIG. 5c, a graph of the intensity of the spectral peak in each image is plotted against pixel location (i.e. wavelength). It will be appreciated from FIG. 5c that the image correction function has increased the spectral power density of peak b). As such, the method of analysing a spectral peak more accurately characterises the intensity associated with a spectral emission. It will also be appreciated that the full width half maximum (FWHM) of the corrected peak (peak b) is reduced to 1.84 pixels relative to the detected peak (peak a) which has a FWHM of 3.38 pixels.

Next, the step of applying an image correction function 103 will be discussed in more detail.

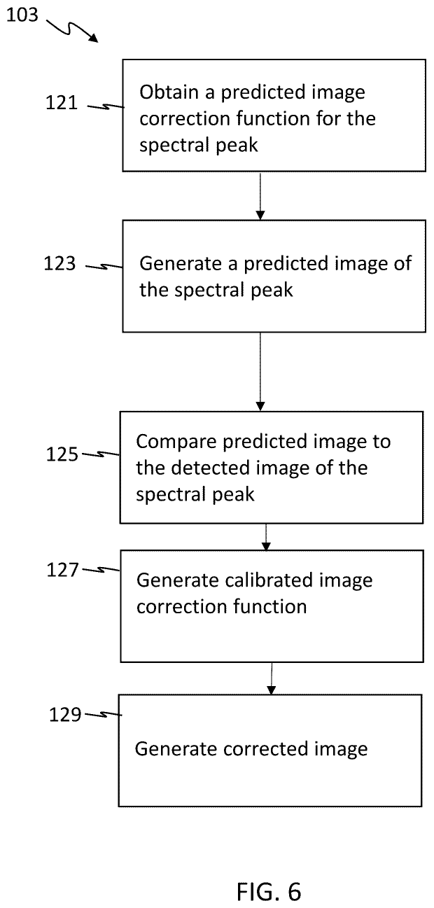

FIG. 6 shows a block diagram of one possible image correction function according to an embodiment of the disclosure. The method of FIG. 6 may be performed by the optical spectrometry system of FIGS. 1 and 3.

In the embodiment of FIG. 6, the processor 14 (as shown in FIG. 1) assumes that the detected image is a degraded representation of the image of the slit 30. The degradation can be represented by a Point Spread Function (PSF). As such, a PSF can be used to describe the response of the imaging system (optics assembly 12) to a point light source. By determining a PSF representative of the image degradation of the optics assembly 12, deconvolution can be used to de-blur the detected image to generate a corrected image.

For an optics assembly 12, ideal models of the various optical components (e.g. mirrors 31, 32, 35, echelle grating 33, prism 34 and lens 36) are well known to the skilled person. As such, the skilled person can generate an initial, theoretical model of the optics assembly in order to arrive at a predicted PSF for the optics assembly. As such, in step 121 the controller obtains a predicted image correction function (predicted PSF) for the spectral peak based on optical characteristics of the optics assembly and the detector of the spectrometer. For example, the predicted PSF may be generated using an optical simulation computer programme (e.g. Zemax). Where a diffractive element (e.g. echelle grating 33) is present in the optics assembly 12, the predicted PSF may depend on the wavelength of the spectral peak being analysed. As such, the predicted PSF obtained may depend on the detector location of the spectral peak. For example, the predicted PSF may be obtained based on the detector location of a centre of the detected image.

In step 123, the controller 14 generates a predicted image of the spectral peak based on the predicted image correction function. For example, in the embodiment of FIG. 2 where a slit 30 is provided, knowledge of the optical properties of the slit 30 and the predicted PSF can be used to generate a predicted image by convolving the predicted PSF with a prediction of the original image (in this case a theoretical image (O) of the slit 30).

In step 125, the predicted image is compared to the detected image. For example, the predicted image may be compared to the detected image to quantify the difference between the predicted image and the detected image. Such a quantification provides an assessment of how accurately the predicted PSF matches the image degradation of the optics assembly 12. Various techniques may be used for quantifying the similarity between the predicted image and the detected image. In the embodiment of FIG. 6, a hash algorithm may be used to compare the two images. In some embodiments a perceptive image hashing algorithm, or a wavelet image hashing algorithm may be used. The hash algorithm outputs a numerical value which is indicative of the difference between the predicted image and the detected image.

For example, in some embodiments the hash algorithm may scale an image into a grayscale e.g. 8×8 image first (other pixel size image hashes may be used). Then an analysis may be performed on each of the 64 pixels and in order to assign each pixel a binary 1 or 0 value. These 64 bits form the output of the algorithm for the image (an image hash). The analysis performed on each pixel depends on the type of image hash algorithm being applied. For example, in an average image hash algorithm a binary 1 value is output if the pixel intensity is greater than or equal to the average pixel intensity of the image, and a binary 0 is output otherwise. In a perceptive image hash algorithm, a Discrete Cosine Transformation may be applied to the 8×8 image, wherein binary values 1 and 0 are assigned based on each pixel being greater at least the average frequency, or lower respectively. For a wavelet image hash algorithm, a Discrete Wavelet Transform may be applied to the 8×8 image, before assigning binary values based on the transformed image.

The image hashes generated for each of the predicted image and the detected image can be compared in order to evaluate the differences between the images. As such, comparing the image hash values (e.g. 64-bit binary numbers) bit-wise provides an evaluation of the similarity of the images. As such, the image hash comparison provides a numerical value (the number of differing bits, or expressed as a percentage of the total number of bits in the image hash) which is indicative of the difference between the two images (a higher value indicating a greater difference between the images).

In step 127, the calibrated image correction function (calibrated PSF) is generated based on the predicted image correction function (predicted PSF) and the comparison of the predicted image of the spectral peak and the detected image of the spectral peak. For example, the output of the hash algorithm may be used calibrate the predicted PSF to more closely reflect the image degradation of the optics assembly 12. As such, the predicted PSF may be calibrated to produce a calibrated PSF based on the output of the image hash algorithm (or other image comparison algorithm).

In the embodiment of FIG. 6, the inventors have realised that one source of error between the predicted PSF (i.e. a PSF generated from theoretical models of the optical components) and the actual PSF of the optics assembly 12 may be characterised as a noise function. Thus, by convolving the predicted PSF with a noise function, a calibrated PSF may be generated. In the embodiment of FIG. 6, the noise function may be low-rank Poisson noise which represents the photon noise present in the optics assembly 12. In some embodiments, the noise function may be represented by a square matrix-of-all-ones, further modified by a Poisson noise term. For detected images where there is a relatively high amount of shot-noise/Poisson noise, including a Poisson noise term in the noise function may allow the calibrated PSF to more accurately reflect the optical properties of the optical spectrometer. By incorporating a Poisson noise term, the noise function may conform to the Poisson distribution:

$$f ( k ; λ ) = P r ( X = k ) = \frac{{λ}^{k} {e}^{- λ}}{k !}$$

The noise function may be generated based on the comparison of the predicted image correction function and the detected image. Thus, the calibrated image correction function may be obtained by convolving the predicted PSF with a noise function based on the comparison, wherein the calibrated PSF more closely matches the actual PSF of the optics assembly (relative to the predicted PSF).

Once the calibrated image correction function is generated, in step 129 a corrected image of the spectral peak is obtained using the calibrated image correction function. In the embodiment of FIG. 6 where the calibrated image correction function is a PSF (calibrated PSF), the corrected image may be obtained by deconvolving the detected image of the spectral peak with the calibrated PSF to obtain the corrected image of the spectral peak. Alternatively, other image correction algorithms which make use of a PSF to correct an image may be applied to obtain the corrected image. For example, the Richardson-Lucy algorithm may be applied using the corrected PSF to obtain the corrected image.

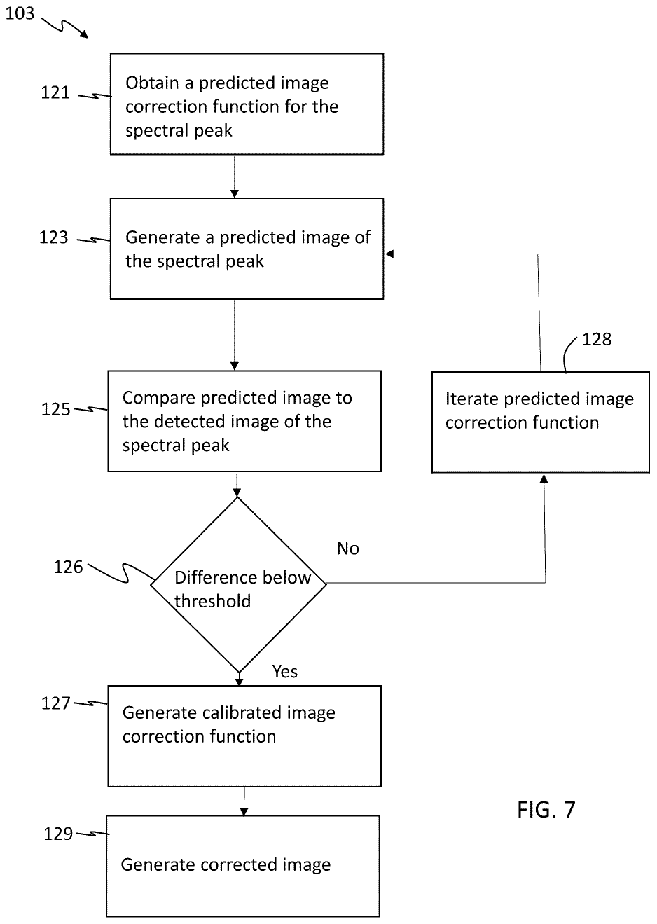

In some embodiments, it may be preferable to iterate the calculation of the calibrated image correction function (calibrated PSF). Thus, FIG. 7 shows a block diagram of an iterative approach for step 103 of applying an image correction function.

In the iterative approach of FIG. 7, the comparison of the predicted image to the detected image may prompt the processor 14 to determine whether the predicted PSF should be further iterated (step 126). As such, where the comparison in step 125 outputs a numerical value indicative of the difference between the predicted image and the detected image, the processor 14 may compare the numerical value to a predetermined threshold. Where the numerical value exceeds the predetermined threshold, the method proceeds to step 128 to iterate the predicted image correction function.

The predicted PSF may be iterated in step 128 in a similar manner to step 127 of calculating the calibrated PSF discussed above. As such, a predicted PSF (P) may be iterated by convolving it with a noise function Nm having a variable size. In some embodiments, the Noise function Nm is a square matrix of all ones.

Thus, in the embodiment of FIG. 7, the predicted PSF (P₁) for the first iteration may be calculated by taking the initially predicted PSF (P₀) and convolving it with a square matrix of all ones J₂ (sometimes referred to as a unit matrix, but not to be confused with an Identity matrix) having order 4 (i.e. a 2×2 unit matrix). That is to say, the first iteration of the predicted PSF may be calculated as:

$${P}_{1} = {P}_{0} ⋆ {J}_{2} . \qquad ( 1 )$$

In equation 1 above, the symbol * is understood to represent convolution of the predicted PSF P₀ with the unit matrix (matrix of ones) J₂. For each iteration of the predicted PSF Pₙ, the order of the square unit matrix is increased (i.e. an (n+1)×(n+1) square matrix). That is to say, the order of the square unit matrix for each iteration is (n+1)². As such, the noise function of variable size is convolved with the initial prediction for the PSF P₀ in order to generate a new predicted PSF. Consequently, for the n^{th} iteration of the predicted PSF (Pₙ), the predicted PSF may be calculated as:

$${P}_{n} = {P}_{0} ⋆ {J}_{n + 1}$$

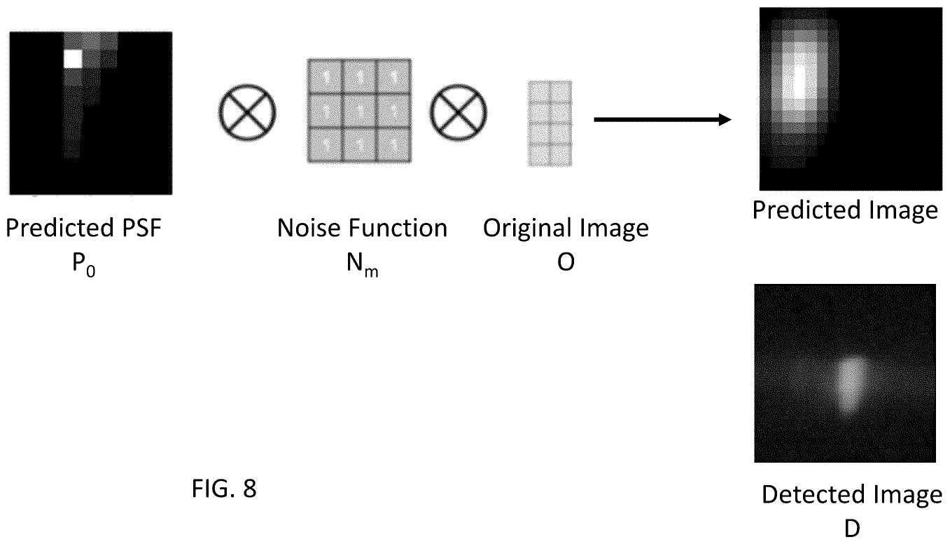

In the above example, a matrix of all ones is used to modify the predicted PSF (P₀). In effect, the iterative method attempts to adapt the predicted PSF to the actual optical distortion present in the optics assembly by assuming that the difference can be characterised by a noise function. In the embodiment of FIG. 7, the noise function is assumed to be represented by an image transformation equivalent to a box blur. While the above-described example uses a box-blur noise function, other image correction matrices may be used in addition, or as an alternative to, the matrix of all one (box blur matrix). For example, alternative noise functions may comprise: a Gaussian blur, an unsharp masking or other similar techniques. It will be appreciated that application of any function may also comprise performing image normalisation on the function. FIG. 8 provides a diagram showing graphically how a predicted image is determined for comparison against the detected image (D).

The iteration may be performed until the difference between the predicted image and the detected image (calculated in step 125 as described above for FIG. 6), fall below a predetermined threshold. That is to say, the predicted image and the detected image are sufficiently similar to indicate that the current predicted PSF (Pₙ) is suitable for use as a calibrated PSF. Thus, in step 127 of FIG. 7, the calibrated image correction function may be determined from the current iteration of the predicted PSF (Pₙ). That is to say, in the embodiment of FIG. 7, the calibrated image correction function is the current iteration of the predicted PSF (Pₙ).

Once the calibrated image correction function is determined, the corrected image is generated in step 129. Step 129 may be performed as described above in relation to FIG. 6, for example using Richardson-Lucy restoration to obtain the corrected image.

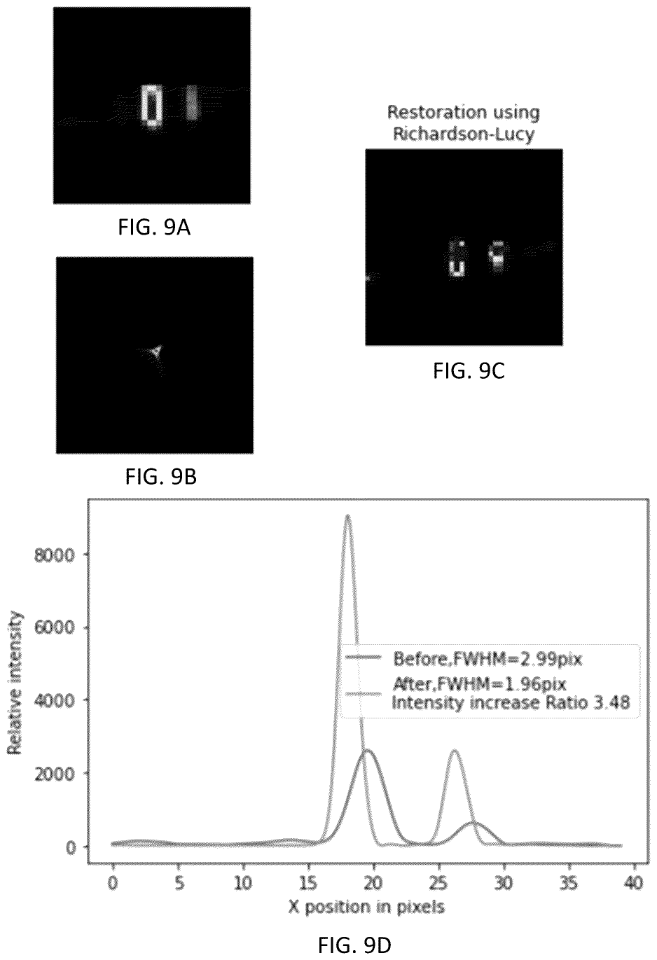

As an example, FIG. 9a depicts a detected image of a spectral peak obtained by an optical spectrometer. FIG. 9b depicts an image of the predicted Point Spread Function obtained by the optical spectrometer. By performing the methods described above (e.g. the method of FIG. 7), a calibrated PSF is obtained which is used to generate a corrected image using Richardson-Lucy restoration, which is shown in FIG. 9c. A graph of the intensity of the spectral peak along an order of the detector can be extracted from the corrected image, as shown in FIG. 9d. FIG. 9d also shows the equivalent information extracted from the detected image for comparison. As can be seen in FIG. 9d, the peak intensity of the corrected peak has increased by a factor of 3.48 and the FWHM of the peak has decreased from 2.99 pixels to 1.96 pixels. It will also be appreciated from FIGS. 9a-9d that a second, lower intensity peak is present in the detected image. The method of analysing a spectral peak has improved the FWHM of the spectral peaks, such that the separation between the two peaks is increased. Thus, it will be appreciated that the methods of this disclosure may be particularly beneficial for the analysis of spectral peaks which are at least partially overlapping.

It will be appreciated that other methods for obtaining a calibrated image correction function may also be utilised. In particular, iterative methods similar to those disclosed in FIG. 7 may be used. For example, a calibrated image correction function may be obtained from a predicted image correction function using a blind deconvolution process. In such a blind convolution process, the predicted PSF and the object image (O) are used to calculate a predicted image. The resulting predicted image is then compared with the detected image. Based on the comparison a correction to the object image (o) and the predicted PSF is computed and employed to generate a new predicted image. The same correction is applied to the predicted PSF, thereby generating a new PSF each iteration estimate.

In some embodiments, the image correction function may be applied in step 103 using an image regularisation process. That is to say, the image degradation process may be expressed in the form of:

$$y = Hx + n$$

where y is the detected image, x is the original (undistorted image), H is a linear degradation operator and n is a noise vector. The objective function of x is defined based on different constraint sets. The solution is then obtained by minimizing the objective function (image correction function) with respect to x. As such, an image correction function can be obtained by an image regularisation process to determine the corrected image y.

In some embodiments, the methods described above may also be performed by an optical absorption spectrometer. In particular, for absorption spectroscopy the spectral peaks of absorption may be present in the detected image as minima, however similar image correction methods may be applied to more accurately extract information from the absorption spectrum.

Thus, according to this disclosure, a method of analysing a spectral peak is provided. It will be appreciated that the methods discussed above may be performed by a controller 14 of an optical spectrometer.

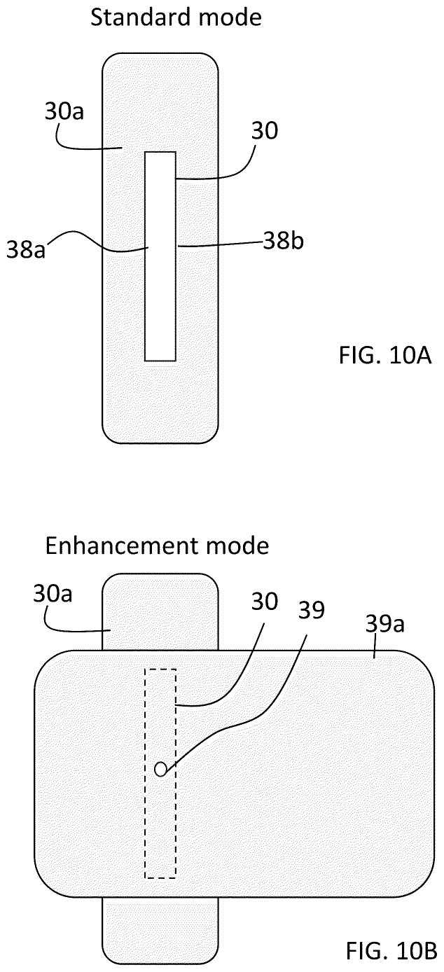

In the above-described embodiments of FIG. 6 and FIG. 7, in step 123 the prediction of the original image used to generate the predicted image is a theoretical image (O) of slit 30. As such, the theoretical image (O) of the slit may be defined by one or more optical characteristics of the slit, for example a width of slit 30. For example, in FIG. 10a a schematic diagram of slit 30 is provided. The slit 30 is defined by two opposing (longitudinal) edges 38a, 38b of a slit member 30a. The two edges 38a, 38b are provided on opposing sides of slit 30 and extend parallel to each other such that the width of slit 30 is constant along a length of the slit.

It will be appreciated that in other embodiments, other optical components and associated optical characteristics may be used to define the original image. For example, FIG. 10b shows a diagram of a pinhole slit 39. The pinhole slit 39 is a circular opening formed in a pinhole member 39a. The circular opening has a constant (known) diameter, such that a theoretical image of the pinhole slit 39 may be defined by a diameter of the pinhole slit 39. In some embodiments, a diameter of the pinhole slit may be about 1-3 μm. Preferably, as shown in FIG. 10b, a diameter of the pinhole slit is smaller than a width of slit 30.

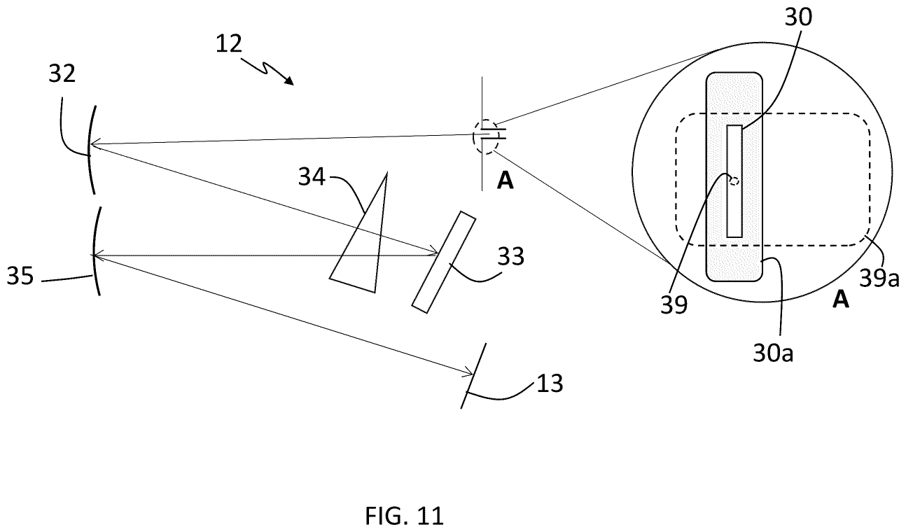

In some embodiments, the optical components used to define the optical characteristics of the optics assembly 12 may be varied in order to improve the accuracy of the calibrated image correction function. As shown in FIGS. 10a, 10b, and 11, the optics assembly 12 may include a slit 30 and a pinhole slit 39. As will be appreciated from FIGS. 10a and 10b, the pinhole slit 39 may be moveable between a first position (standard mode) where the slit 30 is unobstructed, and a second position (enhancement mode) where the pinhole slit 39 obscures the slit such that light is transmitted through the pinhole slit 39. As such, a centre of the pinhole slit 39 is aligned with a centre of slit 30 in the second position. As such, the optics assembly 12 may be operated in a standard mode, or an enhancement mode, in which the optical characteristics are varied between two different settings.

The enhancement mode of the optics assembly 12 may be used to improve the generation of the calibrated image correction function. When operating in the enhancement mode, the optics assembly 12 exposes the detector 14 to light via pinhole slit 39 to obtain a calibration detected image (i.e. pinhole slit 39 is in the second position). A time taken (an exposure time) to obtain the calibration detected image may be increased relative to an exposure time for images obtained in the standard mode, due to the lower light intensity. The calibrated image correction function may then be determined based on a predicted image correction function (for optics assembly 12 including pinhole slit 39) and a comparison of the predicted image of the spectral peak and the calibration detected image of the spectral peak following the methods described above. Due to the longer exposure time, the calibrated image correction function may more accurately determine the required correction to the detected image.

The calibrated image correction function determined in the enhancement mode may then be applied to a detected image obtained in the standard mode. That is to say, following obtaining the calibrated image correction function, the pinhole slit 39 may be moved back to the first position and a detected image may be obtained in the standard mode (using slit 30). The calibrated image correction function may then be applied to the detected image of the spectral peak to obtain a corrected image of the spectral peak.

1. A method of analysing a spectral peak obtained by an optical spectrometer comprising:
imaging a spectral peak using an optics assembly and a detector of the optical spectrometer to generate a detected image of the spectral peak;
applying an image correction function to the detected image of the spectral peak to obtain a corrected image of the spectral peak, wherein the image correction function increases a spectral power density of the spectral peak in the corrected image of the spectral peak; and
extracting information representative of the spectral peak from the corrected image of the spectral peak.

2. A method according to claim 1, wherein applying an image correction function to the detected image of the spectral peak comprises:
obtaining a predicted image correction function for the spectral peak based on optical characteristics of the optics assembly and the detector of the optical spectrometer;
generating a predicted image of the spectral peak based on the predicted image correction function; and
generating a calibrated image correction function based on the predicted image correction function and a comparison of the predicted image of the spectral peak and the detected image of the spectral peak,
wherein the calibrated image correction function is applied to the detected image of the spectral peak to obtain a corrected image of the spectral peak.

3. A method according to claim 2, wherein
obtaining a corrected image of the spectral peak using the calibrated image correction function comprises deconvolving the detected image of the spectral peak with the calibrated image correction function to obtain a corrected image of the spectral peak.

4. A method according to claim 2, wherein
the calibrated image correction function is calculated by convolving the predicted image correction function with a noise function, wherein the noise function is calculated based on the comparison of the predicted image of the spectral peak and the detected image of the spectral peak.

5. A method according to claim 4, wherein the noise function comprises a matrix of all ones.

6. A method according to claim 2, wherein the calibrated image correction function is calculated iteratively until a difference between the predicted image of the spectral peak and the detected image of the spectral peak is below a predetermined threshold.

7. A method according to claim 6, wherein the difference between the predicted image of the spectral peak and the detected image of the spectral peak is calculated using an image hash algorithm.

8. A method according to claim 6, wherein in each iteration of the calibrated image correction function calculation, an order of a noise function is increased.

9. A method according to claim 2, wherein imaging the spectral peak comprises selecting a sub-region of the detector to form the detected image of the spectral peak; and wherein the predicted image correction function and the predicted image are generated for the selected sub-region of the detector.

10. A method according to claim 9, wherein the optics assembly comprises a diffraction grating configured to diffract spectral peaks of different wavelengths to different sub-regions of the detector.

11. A method according to claim 1 wherein the optical spectrometer is an optical emission spectrometer.

12. A method according to claim 1, wherein the detected image of the spectral peak comprises a first spectral peak and a second spectral peak, wherein the first spectral peak and the second spectral peak overlap.

13. A method according to claim 2, wherein,
the predicted image correction function is a predicted point spread function; and
the calibrated image correction function is a calibrated point spread function.

14. A method according to claim 1, wherein the optics assembly comprises a slit and a diffractive element which is configured to distribute the spectral peak to be analysed across the detector.

15. A method according to claim 2, wherein the optics assembly is operable in a first configuration having a first set of optical characteristics, or in a second configuration having a second set of optical characteristics.

16. A method according to claim 15, wherein
a spectral peak is imaged using the optics assembly in the first configuration to generate the detected image of the spectral peak; and
the spectral peak is imaged using the optics assembly in the second configuration to generate a calibration detected image of the spectral peak, wherein
the calibrated image correction function is generated based on the predicted image correction function and a comparison of the predicted image of the spectral peak and the calibrated detected image of the spectral peak; and
the calibrated image correction function is applied to the detected image of the spectral peak to obtain a corrected image of the spectral peak.

17. A controller for an optical spectrometer configured to analyse a spectral peak, wherein the controller is configured to:
cause the optical spectrometer to image a spectral peak using an optics assembly and a detector of the optical spectrometer to generate a detected image of the spectral peak;
apply an image correction function to the detected image of the spectral peak to obtain a corrected image of the spectral peak, wherein the image correction function increases a spectral power density of the spectral peak in the corrected image of the spectral peak; and
to extract information representative of the spectral peak from the corrected image of the spectral peak.

18. An optical spectrometer comprising
a light source configured to output light;
a detector;
an optics assembly configured to direct light from the light source to the detector; and
a controller according to claim 17.

19. A computer-readable medium having stored thereon computer-executable instructions to cause a controller or an optical spectrometer to execute a method, comprising:
applying an image correction function to a detected image of a spectral peak to obtain a corrected image of the spectral peak, wherein the image correction function increases a spectral power density of the spectral peak in the corrected image of the spectral peak; and
extracting information representative of the spectral peak from the corrected image of the spectral peak.

20. The computer-readable medium of claim 19, wherein the applying the image correction function to the detected image of the spectral peak comprises:
obtaining a predicted image correction function for the spectral peak based on optical characteristics of an optics assembly and a detector of the optical spectrometer;
generating a predicted image of the spectral peak based on the predicted image correction function; and
generating a calibrated image correction function based on the predicted image correction function and a comparison of the predicted image of the spectral peak and the detected image of the spectral peak,
wherein the calibrated image correction function is applied to the detected image of the spectral peak to obtain a corrected image of the spectral peak.
